(19) United States
(12) Patent Application Publication
(10) Pub. No.: US 2009/0112524 A1
(43) Pub. Date: Apr. 30, 2009

(54) Method and system for providing measurement equipment support

(76) Inventor: Jan Schiefer, Seattle, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/977,669

(22) Filed: Oct. 25, 2007

(51) Int. Cl. G06F 11/00

(52) U.S. Cl. 702/188

(57) ABSTRACT

A method for providing measurement equipment support includes initiating an alert from a measurement equipment installation to a service support center indicating that support is desired, establishing a direct connection between the measurement equipment installation and the service support center for providing customer support, and utilizing circuitry within the measurement equipment installation to allow a measurement equipment user and the measurement equipment installation to exchange information with the service support center.

### BACKGROUND

The disclosed exemplary embodiments are related to communications between a measurement equipment user and a service support center.

A measurement equipment user may occasionally require support which may range from, for example, troubleshooting inoperative measurement equipment to advice regarding assembling a comprehensive measurement for a module. Contacting an expert or other support personnel for assistance with troubleshooting, performing a measurement, measurement equipment set-up, or for other assistance or services usually involves a telephone call or generally using some type of additional communication device. Obtaining support can be an awkward process when a user must bring a phone and in some instances other equipment, for example a computer, to the measurement equipment, initiate contact with support personnel, and participate in a discussion, usually oral, of the problem and the solution while operating the measurement equipment.

It would be advantageous to provide a more efficient and straightforward support process for the user.

### SUMMARY

The disclosed embodiments are directed to a method for providing measurement equipment support including initiating an alert from a measurement equipment installation to a service support center indicating that support is desired, establishing a direct connection between the measurement equipment installation and the service support center for providing customer support, and utilizing circuitry within the measurement equipment installation to allow a measurement equipment user and the measurement equipment installation to exchange information with the service support center.

The disclosed embodiments are also directed to a measurement equipment installation having an alert mechanism for signaling a service support center that measurement equipment support is desired, a communication function for establishing a direct connection between the measurement equipment installation and the service support center for providing support functions, and communication devices for allowing a measurement equipment user and the measurement equipment installation to exchange information with the service support center.

In addition, a system is disclosed having a service support center including storage for measurement equipment installation information and a first communications facility, and a measurement equipment installation including an alert mechanism for signaling the service support center that measurement equipment support is desired, a second communication function for establishing a direct connection between the measurement equipment installation and the service support center through the first communication facility for providing support functions, and communication devices for allowing a measurement equipment user and the measurement equipment installation to exchange information with the service support center.

### BRIEF DESCRIPTION OF THE DRAWINGS

The foregoing aspects and other features of the presently disclosed embodiments are explained in the following description, taken in connection with the accompanying drawings, wherein:

FIG. 1 shows a block diagram of an exemplary system suitable for practicing the disclosed embodiments;

FIG. 2 shows a block diagram of an exemplary service support center of the system of FIG. 1;

FIG. 3 shows an exemplary measurement equipment installation;

FIG. 4 shows a customer support function of the disclosed embodiments; and

FIG. 5 shows a flow diagram of exemplary operations of the disclosed embodiments.

### DETAILED DESCRIPTION

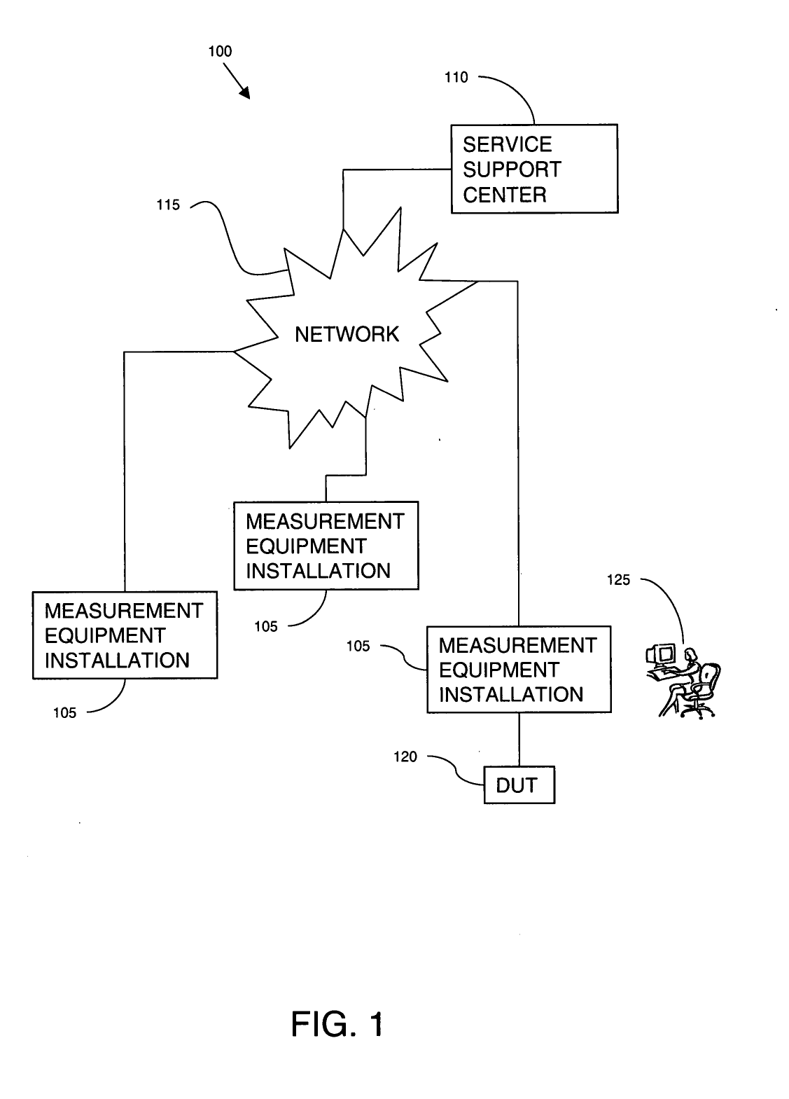

FIG. 1 shows a block diagram of a system 100 suitable for practicing the embodiments disclosed herein. Although the presently disclosed embodiments will be described with reference to the drawings, it should be understood that they may be embodied in many alternate forms. It should also be understood that In addition, any suitable size, shape or type of elements or materials could be used.

System 100 includes one or more measurement equipment installations 105 connected to a service support center 110 through a network 115. A measurement equipment installation 105 may include various measurement system components, for example, a stimulator and a driver for applying signals to a device under test (DUT) 120 and a receiver and analyzer for receiving and analyzing resulting signals from the DUT 120.

It is a feature of the disclosed embodiments to provide access to customer support directly from a measurement equipment installation using a built in customer support function.

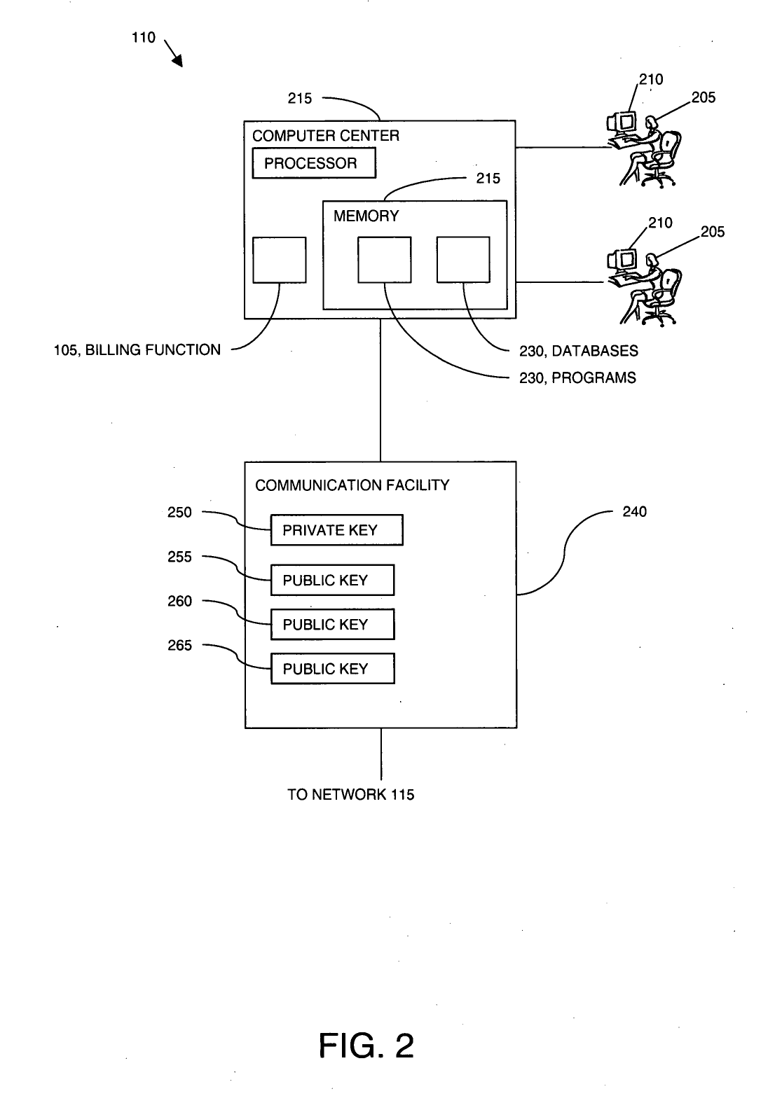

Turning to FIG. 2, the service support center 110 may generally include support personnel 205 with terminals 210 connected to a computer center 215. The computer center 215 may include one or more processors 220 and memory devices 225 with programs 230 and databases 235 for storing information related to various aspects of the measurement equipment installations 105, capabilities of different measurement equipment, troubleshooting procedures, measurement equipment setup information and procedures, records of previous support activities, and other customer support information.

At least one of the processors 220 operates under control of the programs 230 to perform operations according to the disclosed embodiments. The programs 230 may be embodied on a computer readable medium, for example, at least one of the memory devices 225. The one or more memory devices 225 may include magnetic, optical, semiconductor, or any other type of computer readable storage medium. In some embodiments the stored information related to various aspects of the measurement equipment installations may include procedures for retrieving information related to various aspects of the measurement equipment installations 105, capabilities of different measurement equipment, troubleshooting procedures, and measurement equipment setup information and procedures.

The measurement equipment procedures may be implemented as interactive procedures. The interactive procedures may involve the support personnel or may be implemented as automated programs. The measurement equipment procedures may also be implemented as part of the programs 230. In addition, the service support center may include a billing function 245 for collecting costs associated with providing support to the measurement equipment installations and optionally allocating the costs among the measurement equipment installations, billing for customer support, or generally tracking support costs, as appropriate. The billing function may include data related to user accounts, customer company accounts, measurement equipment installation serial numbers, etc. for allocating support costs. The billing function may implemented using the one or more processors 220 and memory devices 225 with programs 230 and databases 235.

The service support center 110 may also provide a communication facility 240 for communicating with the one or more measurement equipment installations 105 and measurement equipment users 125 through the network 115. The communications facility 240 generally includes communications hardware and software for establishing a link between the service support center 110 and a measurement equipment installation 105. The communications facility 240 may also include a private security key 250 for the service support center 110 and public keys 255, 260, 265, etc. for each of the measurement equipment installations 105 for authentication and secure communication.

It should be understood that while one service support center is shown, the service support center 110 may represent a number of service support centers that may be located together or geographically distributed.

The network 115 may include any suitable communications network, for example, the Public Switched Telephone Network (PSTN), a wireless network, a wired network, a Local Area Network (LAN), a Wide Area Network (WAN), a virtual private network (VPN) etc. Communication between the service support center 110 and the measurement equipment installations 105 may be achieved using any suitable protocol or modulation standard, for example, X.25, ATM, TCP/IP, V34, V90, etc. Network 115 may also include a wireless network with an air interface utilizing any suitable wireless communication protocol or signaling techniques or standards, for example TDMA, CDMA, IEEE 802.11, Bluetooth, close range RF, optical, any appropriate satellite communication standards, etc.

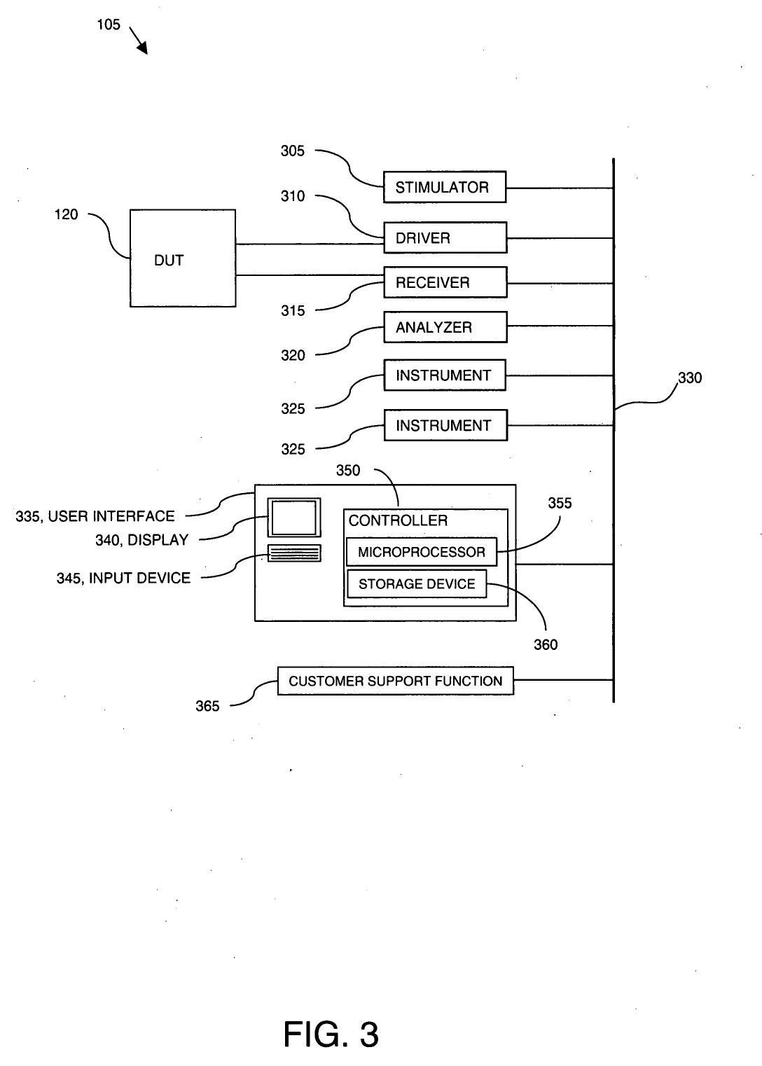

FIG. 3 shows a more detailed view of an exemplary measurement equipment installation 105. As mentioned above, a measurement equipment installation 105 may include one or more of a stimulator 305, driver 310, receiver 315, and analyzer 320. The stimulator 305 may provide one or more test patterns, also referred to as test vectors, for obtaining measurements from the DUT 120. The test patterns may include digital, analog, optical, or any suitable type of test signal. The driver 310 may provide the signals to the DUT 120 through a hardware interface, for example, using one or more cables, an air interface, for example, using a broadcast transmission, or any other conveyance suitable for providing signals to the DUT 120.

When the test patterns are provided to the DUT 120, the DUT in return provides response signals, such as digital, analog, optical, or any types of signals. The response signals may be different in form from the test patterns, for example, a combination of analog and optical signals may result in the DUT producing digital signals as a response. The receiver 315 operates to convey the response signals from the DUT 120 to the analyzer 320. In some embodiments the receiver 315 may include components for conditioning the response signals before conveying them to the analyzer 320. The analyzer 320 may evaluate the DUT's responses to the test patterns and may provide an indicator, for example one or more signals, of the evaluation. The indicators provided by the analyzer may simply include a measurement of the DUT's response, a comparison of the DUT's response with an expected response, a pass/fail indication, an analysis of the DUT's response with specific component failures, or any other suitable analysis of the DUT response.

In some embodiments the stimulator 305 and driver 310 may be combined to perform a specialized or dedicated type of stimulus function or provide a specific type of signal, as in the example of a frequency generator. Similarly, in some embodiments the receiver 315 and analyzer 320 may be combined to provide a specialized or dedicated analysis function, as in the example of an oscilloscope. Measurement system components including those with dedicated or specialized functions may be referred to as instruments 325.

A measurement equipment installation 105 may include one or more of, or any combination of, stimulators, drivers, receivers, analyzers, or dedicated instruments, and may be modular and scalable so that necessary measurement system components may be assembled together as required. The measurement system components may be interconnected to each other, or in some embodiments may be connected by a common bus 330 for communication with each other.

The measurement equipment installation 105 may also include a user interface 335. The user interface may be a separate component of the measurement equipment installation 105 or may be incorporated as part of one or more instruments 325. The user interface 335 may include a display 340, at least one input device 345, and a controller 350. The display 335 may utilize LCD, flat panel, plasma, or any other type of suitable technology. The at least one input device 345 may include one or more buttons, a keypad, keyboard, a pointing device such as a mouse or trackball, etc. for selecting a number of options and embellishments of a product as will be described below. The controller 350 may include a microprocessor 355 or other appropriate circuitry for controlling the operations of the user interface. The controller 350 may also include a storage device 360 embodied as a computer readable medium that generally stores machine readable program code which is adapted to cause the controller to perform the functions of the disclosed embodiments. The storage device 360 may utilize optical, magnetic, semiconductor, electronic, or other types of suitable devices to store the program code.

Other examples of a user interface may include a consumer computing device such as a personal digital assistant (PDA), cellular telephone, desktop, laptop, notebook, etc. The user interface 335 may include any computing device capable of providing the functions described herein.

The measurement equipment installation 105 may also include a built in customer support function 365. In some embodiments the entire customer support function 365 may be implemented as a separate component of the measurement equipment installation. For example, where the measurement equipment installation includes instruments 325 connected by a bus 330, the customer support function may be provided, or even retrofitted, as a modular component on the bus 330. While shown as a component of a measurement equipment installation 105, it should be understood that the customer support function 365 may also be implemented as a function distributed among any number of measurement system components. In other embodiments, the customer support function 365 may be integrated into the user interface 335, one or more measurement system components, or instruments 325.

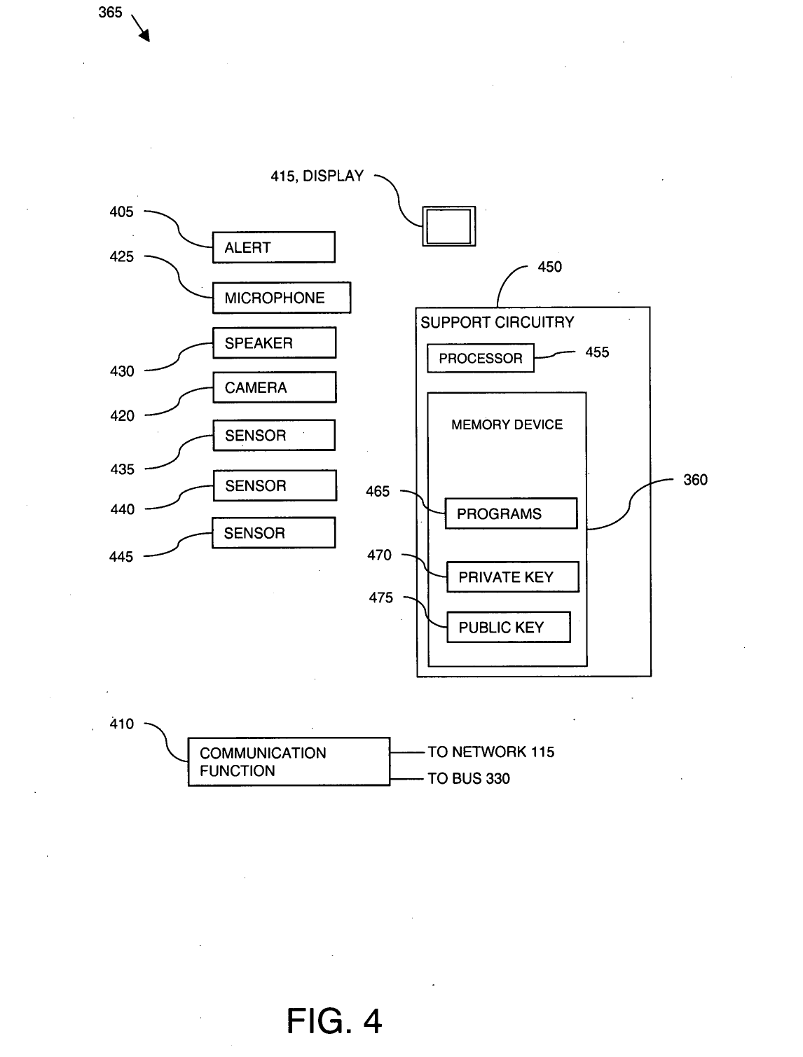

FIG. 4 shows the customer support function 365 in greater detail. The customer support function 365 may include an alert mechanism 405 for notifying the service support center 110 that assistance is required. The mechanism may include one or more functions or devices of the user interface 335, for example, a button on the measurement equipment installation or on an instrument, a soft key, a menu selection, or a clickable link on the display, a command entered through the display, or any other device or technique suitable for allowing a user 125 (FIG. 1) to initiate an alert. In other embodiments, the alert mechanism 405 may be a separate component of the measurement equipment installation.

The built in customer support function 365 may also include a communication function 410 that is capable of establishing a link with the service support center 110 for exchanging information through network 115. The communication function 410 may generally include circuitry and programs for providing a direct communication link between the measurement equipment installation 105 and the service support center 110. The direct communication link may include, for example, an instant messaging (IM) client or other suitable “chat” type technology, a plain old telephone service (POTS) connection, a voice over IP (VOIP) connection, a video connection, a multimedia message exchange, a network connection, or any suitable messaging, voice, video, data, or information exchange link.

For embodiments where the customer support function is connected to the common bus 330, the communication function 410 may also include a module 470 with circuitry for providing communication among the customer support function 365 and other instruments of the measurement equipment installation 105.

The customer support function 365 may also include communication devices, circuitry, and programs. For example, the customer support function 365 may include components of the user interface 335, for example, display 340 and input device 345, one or more of an additional display 415, a camera 420, microphone 425, speaker 430, sensors 435, 440, 445 and other communication devices for providing communication with the measurement equipment installation user 125. The support circuitry 450 may include circuitry for using the communication devices, for example, display 415, camera 420, microphone 425, speaker 430, and sensors 435, 440, 445 as a telephone, videophone, or any other suitable interactive interface or communication apparatus between the measurement equipment user 125 and the service support center 110.

The support circuitry 450 may also include a processor 455 and a memory device 460. The processor 455 may operate under control of programs to perform customer support operations according to the disclosed embodiments. The communication devices, circuitry and programs may support a measurement equipment user voice recognition capability. The programs 465 may be embodied on a computer readable medium, for example, memory device 460. The programs may provide access control, for example, by requiring a test equipment user 125 to login with a user name and password. Other access control techniques may also be implemented. The one or more memory devices 225 may include magnetic, optical, semiconductor, or any other type of computer readable storage medium. The memory device 460 may also include a private key 470 for the measurement equipment installation 105 and a public key 475 for the service support center 110 for authentication and secure communication.

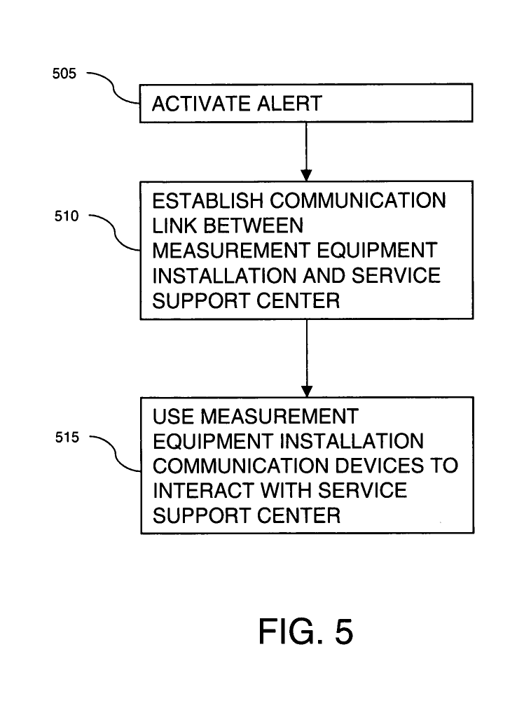

Exemplary operations of the disclosed embodiments will now be described. Referring to FIG. 5, in one embodiment, the measurement equipment user 125 may activate the alert mechanism 405 to signal that the user desires assistance, as shown in block 505. The built in customer support function 365 may then establish a communication link through the network 115 with the service support center 110, as shown in block 510. The customer support function 365 may initiate communication by encrypting an identification message with the measurement equipment installation's private key 470 and sending it to the service support center 110. The identification message may include an identifier of the measurement equipment installation, for example, a serial number, a name, a customer account code, or any other measurement equipment installation identifying information. Upon receipt, the service support center 110 may decrypt the message with the measurement equipment installation's public key 255 and authenticate the measurement equipment installation 105 by confirming that the measurement equipment installation identifier matches the identifier associated with the public key 255.

The service support center 110 may respond with an identification message encrypted with the service support center's private key 250. The service support center's identification message may include an identifier similar to the measurement equipment installation identifier that clearly identifies the service support center 110. Upon receipt, the measurement equipment installation 105 may decrypt the message with the service support center's public key and authenticate the service support center 110 by confirming that the service support center identifier matches the identifier associated with the public key 475. Subsequently all communication between the measurement equipment installation 105 and the service support center may be encrypted with private keys and decrypted with public keys in a similar fashion, ensuring secure authenticated communication.

The measurement equipment user 125 may utilize one or more of the communication devices 340, 345, 415, 420, 425, 430, 435, 440, 445 to interact with support personnel 205 or with an automated procedure at the service support center 110, as shown in block 510. The interaction over the communication link may use an IM session, a conventional telephone connection, a VOIP session, a video conference, a multimedia message exchange, or any other suitable technology supported by the customer support function 365 and the service support center 110. The interaction over the communication link may be interactive among the measurement equipment user 125, the service support personnel 205, an automated program at the service support center, or a combination of the service support personnel 205 and an automated program. The built in customer support function 365 allows the measurement equipment user 125 to establish a connection directly from the measurement equipment installation 105 to the service support center 110 and allows the user 125 to interact directly with the service support center 110.

The assistance provided by the service support center 110 and the service support personnel 205 may include any assistance desired by the measurement equipment user 125. After the measurement equipment user 125 has activated the alert mechanism 405 and a direct connection between the measurement equipment installation 105 and the service support center 110 has been established, the measurement equipment installation 105 and the service support center 110 may exchange measurement support information. For example, the user may be presented with a menu of support functions, such as measurement equipment set up for different types of measurements or measurement equipment troubleshooting. The support personnel 205 or automated procedure may then provide advice or proceed through various decision trees to provide the desired information. Exemplary functions provided by the support personnel 205 or automated procedure as part of the information exchange may include identifying the desired types of measurements, identifying the measurement equipment components or instruments required, identifying any required interconnections among the components or instruments, interrogating the measurement equipment installation 105 and retrieving information regarding the types of instruments and interconnections, assuming control over the measurement equipment installation 105, running instrument diagnostics, or any other type of support activity.

Thus, the disclosed embodiments provide a measurement equipment user with access to customer support directly from a measurement equipment installation, without the need to bring other equipment, for example, a phone or a computer, to the measurement equipment. The disclosed embodiments generally provide for enhanced customer support by establishing a direct link between the measurement equipment installation 105 and the service support center 110, providing additional communication devices and by performing some support functions automatically.

It should be understood that the foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the appended claims.

What is claimed is:

1. A method for providing measurement equipment support comprising:
initiating an alert from a measurement equipment installation to a service support center indicating that support is desired;
establishing a direct connection between the measurement equipment installation and the service support center for providing customer support;
utilizing circuitry within the measurement equipment installation to allow a measurement equipment user and the measurement equipment installation to exchange information with the service support center.

2. The method of claim 1, further comprising initiating the alert through a user interface of the measurement equipment installation.

3. The method of claim 1, further comprising initiating the alert through a component of the measurement equipment installation.

4. The method of claim 1, wherein establishing a direct connection between the measurement equipment installation and the service support center includes authenticating the measurement equipment installation and the service support center.

5. The method of claim 1, wherein the measurement equipment user exchanges information with the service support center utilizing an interactive interface.

6. The method of claim 1, wherein the measurement equipment user and the measurement equipment installation exchange information with the service support center utilizing automated programs.

7. The method of claim 1, wherein the information exchanged with the service support center includes measurement support information.

8. The method of claim 1, wherein the information exchanged with the service support center is encrypted.

9. A measurement equipment installation comprising:
an alert mechanism for signaling a service support center that measurement equipment support is desired;
a communication function for establishing a direct connection between the measurement equipment installation and the service support center for providing support functions; and
communication devices for allowing a measurement equipment user and the measurement equipment installation to exchange information with the service support center.

10. The measurement equipment installation of claim 9, wherein the alert mechanism includes one or more devices of a user interface of the measurement equipment installation.

11. The measurement equipment installation of claim 9, wherein the communication function includes a module providing communicating among instruments of the measurement equipment installation and the service support center.

12. The measurement equipment installation of claim 9, wherein the communication devices are coupled by support circuitry to provide an interactive interface between the measurement equipment user and the service support center.

13. The measurement equipment installation of claim 9, further comprising encryption keys for authenticating and encrypting communication between the measurement equipment installation and the service support center

14. A system comprising:
a service support center including:
storage for measurement equipment installation information; and
a first communications facility;
a measurement equipment installation including:
an alert mechanism for signaling the service support center that measurement equipment support is desired;
a second communication function for establishing a direct connection between the measurement equipment installation and the service support center through the first communication facility for providing support functions; and
communication devices for allowing a measurement equipment user and the measurement equipment installation to exchange information with the service support center.

15. The system of claim 14, wherein the measurement equipment installation information includes interactive support procedures.

16. The system of claim 14, wherein the service support center includes a billing function for collecting costs associated with providing support to the measurement equipment installations.

17. The system of claim 14, wherein the alert mechanism includes one or more devices of a user interface of the measurement equipment installation.

18. The system of claim 14, wherein the second communication function includes a module providing communication among instruments of the measurement equipment installation and the service support center.

19. The system of claim 14, wherein the communication devices are coupled by support circuitry to provide an interactive interface between the measurement equipment user and the service support center.

20. The system of claim 14, wherein communication between the service support center and the measurement equipment installation is authenticated and encrypted.
